(19) United States
(12) Patent Application Publication
(10) Pub. No.: US 2026/0024212 A1
(43) Pub. Date: Jan. 22, 2026

(54) ADVANCED IMAGE TRACING FOR VECTORIZING RASTER IMAGES

(71) Applicant: Adobe Inc., San Jose, CA (US)

(72) Inventors: Gagan Singhal, Shakur Basti (IN); Shefali Jain, Faridabad (IN); Shikhar Tayal, ALIGARH (IN); Shreya Anand, Roorkee (IN); Nilesh Mishra, Kanpur (IN)

(21) Appl. No.: 18/774,082

(22) Filed: Jul. 16, 2024

(51) Int. Cl. G06T 7/13; G06T 5/40; G06V 10/46; G06V 10/56; G06V 10/75

(52) U.S. Cl. CPC G06T 7/13; G06T 5/40; G06V 10/46; G06V 10/56; G06V 10/751; G06T 2207/20084

(57) ABSTRACT

The present disclosure relates to systems, non-transitory computer-readable media, and methods for detecting and tracing edges in raster images using an advanced edge detection algorithm. For example, the disclosed systems generate, for a sliding pixel window in a raster image, a local histogram ranking of pixels according to pixel values located within the sliding pixel window. In some embodiments, the disclosed systems determine, for a region of the raster image enclosed by the sliding pixel window, an edge strength for an edge depicted in the raster image by comparing pixel ranks indicated by the local histogram ranking of the pixels. In certain embodiments, the disclosed systems also provide the edge for display based on determining the edge strength for the region of the raster image enclosed by the sliding pixel window.

### BACKGROUND

Converting raster images into vector graphics is a fundamental task in graphic design. Over the years, systems have been developed to convert raster images to vector graphics using a variety of methods, from input-driven tracing using graphical pen tools to image tracing features that generate an overabundance of anchor points for vector segments based on raster image content and which thus require further pruning and refining. While existing systems provide some limited tools for tracing edges in raster images, these systems exhibit a number of technical deficiencies, especially regarding accuracy in identifying edges in complex images and flexibility in selectively tracing and editing parts of images.

### SUMMARY

Embodiments of the present disclosure provide benefits and/or solve one or more of the foregoing or other problems in the art with systems, non-transitory computer-readable media, and methods for detecting and tracing edges in raster images using an advanced edge detection algorithm. For example, the advanced edge detection process of the disclosed systems involves using a pixel window algorithm that includes generating local histogram rankings of pixels values using a sliding pixel window across a raster image and determining edge strengths for edges indicated by the local histogram rankings. In some embodiments, the advanced edge detection algorithm also includes using a segmentation neural network to detect object contours and superimposing the object contours on an edge map generated from the pixel window algorithm. In one or more embodiments, the disclosed systems further introduce processes for determining and selecting edge granularities, extrapolating edges from incomplete or sparse image regions, and/or tracing edges using hit tests, smoothening, and/or single-click inputs. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which an edge detection system operates in accordance with one or more embodiments.

FIG. 2 illustrates an example overview of detecting edges in a raster image and using the detected edges to perform additional downstream processes in accordance with one or more embodiments.

FIG. 3 illustrates an example of using a pixel window algorithm to detect edges of a raster image in accordance with one or more embodiments.

FIG. 4 illustrates an example process of detecting edges in a raster image using a pixel window algorithm together with a segmentation neural network in accordance with one or more embodiments.

FIG. 5 illustrates an example set of contour images depicting edges of different hierarchical granularities in accordance with one or more embodiments.

FIG. 6 illustrates an example of extrapolating edges in accordance with one or more embodiments.

FIG. 7 illustrates an example interface for tracing tools in accordance with one or more embodiments.

FIGS. 8A-8B illustrate an example comparison of detected edges in accordance with one or more embodiments.

FIG. 9 illustrates an example schematic diagram for an edge detection system in accordance with one or more embodiments.

FIG. 10 illustrates an example series of acts for detecting edges in a raster image using a pixel window algorithm in accordance with one or more embodiments.

FIG. 11 illustrates an example series of acts for generating a vector image from a raster image by detecting and tracing edges using a pixel window algorithm and an object segmentation neural network in accordance with one or more embodiments.

FIG. 12 illustrates an example series of acts for generating a vector image from a raster image by detecting and tracing edges using a pixel window algorithm for channel-specific analysis in accordance with one or more embodiments.

FIG. 13 illustrates a block diagram of an example computing device for implementing one or more embodiments of the present disclosure.

### DETAILED DESCRIPTION

This disclosure describes one or more embodiments of an edge detection system that detects edges in raster images using advanced edge detection techniques that involve a pixel window algorithm. Vectorizing raster images is often a part of graphic design, and converting raster images into vector graphics provides powerful functions for selecting and editing curves or edges depicting in digital images. As part of converting a raster image into a vector image, the edge detection system uses a pixel window algorithm to populate a pixel rank histogram with local histogram rankings of pixels enclosed by the window. From the local histogram rankings, in one or more embodiments, the edge detection system determines edge strengths of edges detected in the sliding pixel window. In some embodiments, the edge detection system also utilizes a segmentation neural network to detect object contours and superimposes the object contours on an edge map of the sliding pixel window. In certain cases, the edge detection system performs downstream processes on detected edges, such as determining edge granularity, contour extrapolation, and/or edge tracing to generate vectorized versions of raster images (e.g., with freehand tracing tools or with a one-click input).

As just mentioned, in some embodiments, the edge detection system detects edges in a raster image using a pixel window algorithm. For example, the pixel window algorithm involves a two-step process: 1) area ranking and 2) area differentiation. In some cases, the pixel window algorithm includes splitting a raster image into multiple color channels (e.g., red, green, and blue) and applying the area ranking and area differentiation processes to each channel (or channel-specific version of the image) before merging the results together to determine edges in the original image.

For area ranking, in one or more embodiments, the edge detection system uses a sliding pixel window to process different regions or portions of the raster image. In some cases, the edge detection system determines a neighborhood of pixels enclosed within the sliding pixel window and determines a local ranking of pixel values in the neighborhood. In one or more embodiments, the edge detection system uses a pixel rank histogram to generate a local histogram ranking of the pixels enclosed by the sliding pixel window. For area differentiation, in some embodiments, the edge detection system determines an edge strength indicated by the difference between minimum and maximum pixel values within a local neighborhood. For example, the edge detection system compares pixel values or pixel ranks of pixels as indicated by a local (histogram) ranking of pixels.

In one or more embodiments, the edge detection system detects edges in a raster image by using a segmentation neural network together with the pixel window algorithm. For example, the edge detection system uses a segmentation neural network to detect object contours for objects depicted in the raster image and combines the output of the network with the output from the pixel window algorithm. In some cases, this involves superimposing the object contours from the segmentation neural network on an edge map indicated by edge strengths of the pixel window algorithm.

In some embodiments, the edge detection system performs additional downstream processes on detected edges. For instance, the edge detection system determines or generates granularity levels for detected edges through a hierarchical contour process. In addition, in some cases, the edge detection system performs an edge extrapolation process to determine or predict edges in sparse or incomplete regions of a raster image. Further, in certain embodiments, the edge detection system provides tracing tools for freehand tracing and/or one-click tracing of the raster image to convert the raster image into a vector image.

As suggested above, many conventional systems exhibit a number of shortcomings or disadvantages, particularly in accurately detecting or identifying edges in digital images. To elaborate, many existing systems determine inaccurate and/or incomplete edges from content of a raster image by using detection algorithms based on image gradients, luminance detection, and/or convolution of kernels (e.g., Sobel kernels). Such existing systems are prone to generating false positives that result in erroneous edge detection (e.g., by placing edges in regions where there are no edges) and/or broken or spurious edges which is especially true in kernel-based systems that are susceptible to noise. Additionally, certain existing systems cannot account for directionality of detected edges and/or cannot detect edges that are not apparent from grayscale image conversions. The inaccuracies of prior systems are more pronounced when applied to complex images with detailed geometry.

Due at least in part to their inaccuracies, many prior systems are also inefficient. For example, some existing systems consume excessive computer memory and storage by generating and storing vectorized edges (e.g., through tracing) that contain an overabundance of anchor points, along with large amounts of fill data and stroke data. In addition, due to the inaccuracies in their edge detection, certain prior systems require excessive numbers of device interactions to edit and refine edges for correcting errors. Thus, not only do prior systems waste computer storage with bloated edge data, but they also require excessive interactions to define edges and/or to trace edges in images.

As suggested above, embodiments of the edge detection system provide certain improvements or advantages over conventional systems. For example, embodiments of the edge detection system improve accuracy in detecting edges depicted in digital images. Embodiments of the edge detection system exhibit such accuracy improvements due to using a pixel window algorithm (in combination with a segmentation neural network) to detect edges based on local (histogram) rankings of pixel values. By using the two-stage pixel window algorithm, the edge detection system reduces broken or spurious edges and/or other erroneous edge detection exhibited by prior gradient-based, luminance-based, and/or kernel-based systems. Indeed, the pixel window algorithm of the edge detection system is less susceptible to noise than prior systems (especially those that are kernel-based), accounts for directionality in detecting edges unlike prior systems, and is also more robust to variations in illumination and texture. In some cases, the edge detection system provides even better accuracy by combining object contours detected using a segmentation neural network with an edge map defined by the pixel window algorithm. The accuracy improvements of the edge detection system are especially pronounced in images depicting complex geometry with many complicated edges.

Due at least in part to improving accuracy over prior systems, embodiments of the edge detection system also improve efficiency over prior systems. For instance, by using the pixel window algorithm as the basis for tracing a raster image, the edge detection system reduces the storage requirements of edge data compared to the bloated size or vectors in prior systems. In addition, in some embodiments, the edge detection system reduces the number of device interactions compared to prior systems. For example, the edge detection system detects more accurate edges which reduces the number of interactions otherwise required to reduce or correct errors. Additionally, as opposed to prior systems that require many inputs to trace edges of an image, the edge detection system provides a one-click tracing feature to detect and trace image edges with a single interaction.

In addition to improving accuracy and efficiency, embodiments of the edge detection system also provide improved flexibility. Indeed, beyond introducing the pixel window algorithm as a new mechanism for detecting edges in an image, the edge detection system also provides tools for determining edge granularities. Thus, unlike prior systems that detect a single set of edges for a digital image, the edge detection system generates a flexible hierarchy of contour granularities with parent and child contours reflecting different levels of detail in the image. Accordingly, by generating a hierarchical contour structure, the edge detection system adapts to different granularity levels of edges.

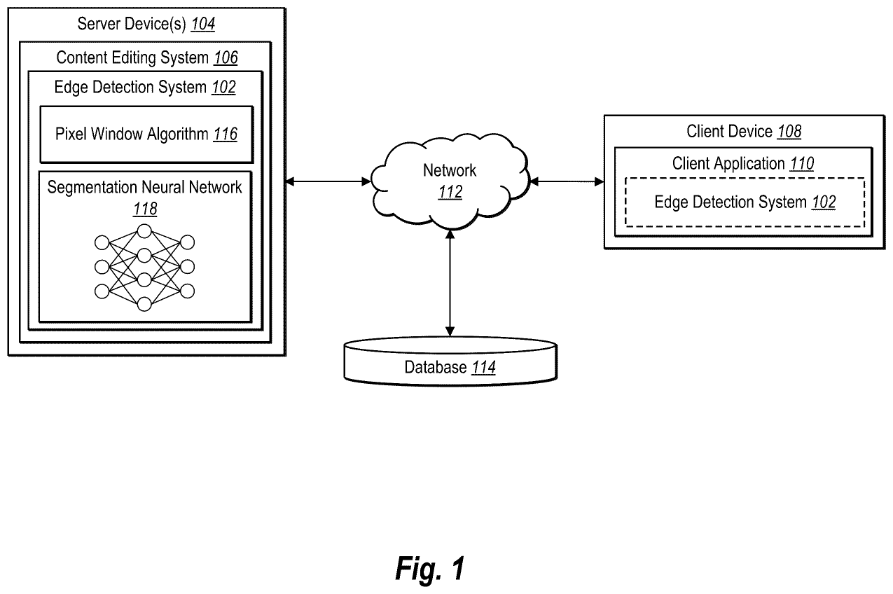

Additional detail regarding the edge detection system will now be provided with reference to the figures. For example, FIG. 1 illustrates a schematic diagram of an example system environment for implementing an edge detection system 102 in accordance with one or more embodiments. An overview of the edge detection system 102 is described in relation to FIG. 1. Thereafter, a more detailed description of the components and processes of the edge detection system 102 is provided in relation to the subsequent figures.

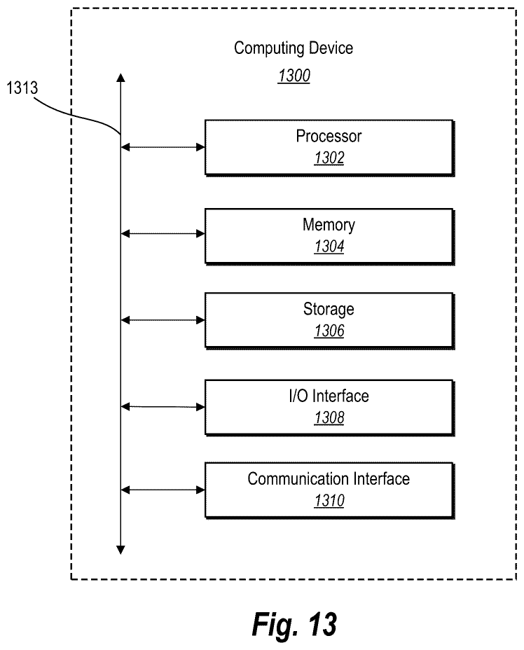

As shown, the environment includes server device(s) 104, a client device 108, a database 114, and a network 112. Each of the components of the environment communicate via the network 112, and the network 112 is any suitable network over which computing devices communicate. Example networks are discussed in more detail below in relation to FIG. 13.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 13. Although FIG. 1 illustrates a single instance of the client device 108, in some embodiments, the environment includes multiple different client devices, each associated with a different user. The client device 108 communicates with the server device(s) 104 and/or the content editing system 106 via network 112. For example, the client device 108 receives information from the server device(s) 104 and provides information to server device(s) 104 relating to raster images, vector images, and detected edges.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server device(s) 104. The client application 110 presents or displays information to a user, including a content editing interface for using edge detection tools and/or tracing tools to detect, modify, and/or trace edges of a digital image.

As also illustrated in FIG. 1, the environment includes the server device(s) 104. The server device(s) 104 generates, tracks, stores, processes, receives, and transmits electronic data, such as raster images, vector images, object contours, detected edges, vector data for traced edges, and/or granularity data for hierarchical contours. For example, the server device(s) 104 receives data from the client device 108 in the form of a raster image and an indication to detect depicted edges. In response, the server device(s) 104 provides data to the client device 108 in the form of a vectorized image and/or detected edges, as described herein. For example, the server device(s) 104 communicate with the database 114 to access a pixel window algorithm 116 a trained neural network, such as the segmentation neural network 118.

In some embodiments, the server device(s) 104 communicates with the client device 108 to transmit and/or receive data via the network 112. In some embodiments, the server device(s) 104 comprises a distributed server where the server device(s) 104 includes a number of server devices distributed across the network 112 and located in different physical locations. The server device(s) 104 comprise a content server, an application server, a communication server, a web-hosting server, a multidimensional server, or a machine learning server.

As further shown in FIG. 1, the server device(s) 104 also includes the edge detection system 102 as part of a content editing system 106. For example, in one or more implementations, the content editing system 106 stores, generates, modifies, edits, enhances, provides, distributes, and/or shares digital content, such as digital images. For example, the content editing system 106 provides digital content for editing or other forms of digital processing. In some implementations, the content editing system 106 provides digital content to particular digital profiles associated with client devices (e.g., the client device 108).

In one or more embodiments, the server device(s) 104 includes all, or a portion of, the edge detection system 102. For example, the edge detection system 102 operates on the server device(s) 104 to detect edges and/or convert raster images into vector images through tracing detected edges. In some embodiments, the client device 108 includes all or part of the edge detection system 102. For example, the client device 108 generates, obtains (e.g., downloads), or uses one or more aspects of the edge detection system 102, such as the pixel window algorithm 116 and/or the segmentation neural network 118. Indeed, in some implementations, as illustrated in FIG. 1, the edge detection system 102 is located in whole or in part of the client device 108 (e.g., as part of the client application 110). For example, the edge detection system 102 includes a web hosting application that allows the client device 108 to interact with the server device(s) 104. To illustrate, in one or more implementations, the client device 108 accesses a web page supported and/or hosted by the server device(s) 104.

In one or more embodiments, the client device 108 and the server device(s) 104 work together to train and/or implement models of the edge detection system 102. For example, in some embodiments, the server device(s) 104 train one or more neural networks (e.g., the segmentation neural network 118) and provide the one or more neural networks to the client device 108 for implementation. In some embodiments, the server device(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the edge detection system 102 is implemented by (e.g., located entirely or in part on) the client device 108. As another example, the pixel window algorithm 116 and/or the segmentation neural network 118 are stored in the database 114. In addition, in one or more embodiments, the client device 108 communicates directly with the edge detection system 102, bypassing the network 112.

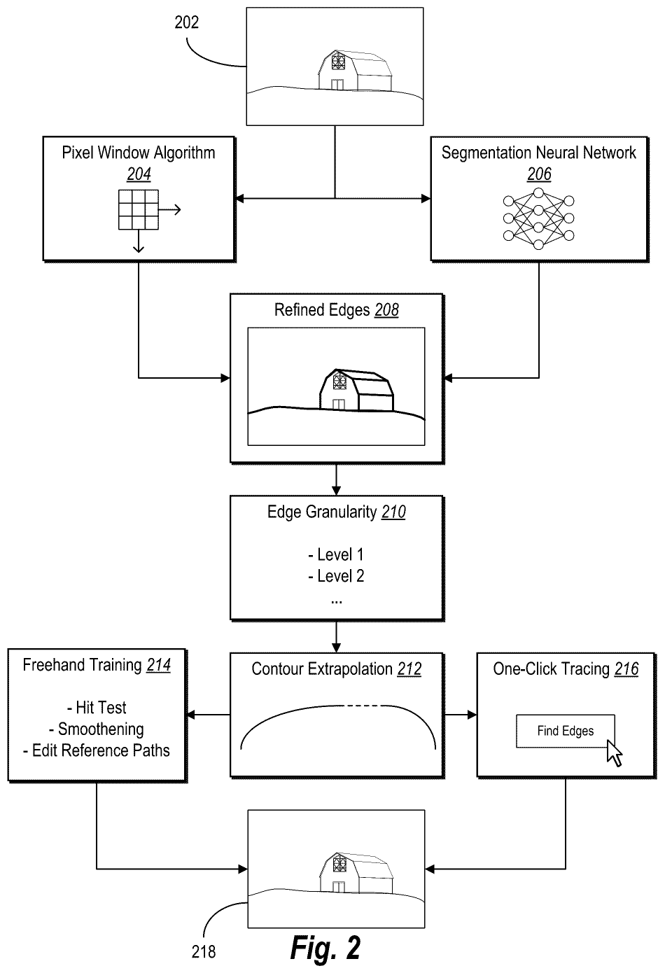

As mentioned, in one or more embodiments, the edge detection system 102 detects edges from content depicted in a raster image. In particular, the edge detection system 102 utilizes a pixel window algorithm and/or a segmentation neural network to detect edges depicted in a raster image. In addition, the edge detection system 102 performs downstream processes on the detected edges. FIG. 2 illustrates an example overview of detecting edges in a raster image and using the detected edges to perform additional downstream processes in accordance with one or more embodiments. Additional detail regarding the various acts and processes introduced in relation to FIG. 2 is provided thereafter with reference to subsequent figures.

As illustrated in FIG. 2, the edge detection system 102 identifies or receives a raster image 202. In particular, the raster image 202 depicts raster content (e.g., non-vectorized image content) arranged in a gride of individual pixels with pixel values. In some cases, a pixel value includes or refers to a numerical representation of a magnitude or intensity corresponding to an aspect of content depicted in a pixel, such as color or luminance. In one or more embodiments, the edge detection system 102 splits or divides the raster image 202 into multiple color channels. For example, the raster image 202 includes three color channels (e.g., red, green, and blue), where each pixel in the raster image 202 has a corresponding pixel value for each of the three channels. The edge detection system 102 thus splits the raster image 202 into its color channels, generating channel-specific versions of the raster image 202, one for each color channel.

As further illustrated in FIG. 2, the edge detection system 102 utilizes a pixel window algorithm 204 (e.g., the pixel window algorithm 116) to detect edges depicted in the raster image 202. To elaborate, the pixel window algorithm 204 includes two stages: one for area ranking, and one for area differentiation. The edge detection system 102 executes the two stages of the pixel window algorithm 204 on each of the color channels of the raster image 202 to detect channel-specific edges. The edge detection system 102 further combines the channel-specific data together to ultimately generate detected edges.

For the area ranking stage of the pixel window algorithm 204, the edge detection system 102 uses a sliding pixel window to process different regions or portions of the raster image 202. In some cases, a sliding pixel window includes or refers to a window or area of pixels defined by computer code to encompass a neighborhood of pixels at a given location and which can be placed or moved across various locations of a digital image. For each pixel of the raster image 202, the edge detection system 102 determines a neighborhood of pixels enclosed within the sliding pixel window and determines a local ranking of pixel values in the neighborhood, assigning or setting a new pixel value (e.g., a pixel rank) to the pixel based on its position in the local ranking.

In some cases, the edge detection system 102 uses a pixel rank histogram to generate a local histogram ranking of the pixels enclosed by the sliding pixel window. For instance, the edge detection system 102 generates a pixel rank histogram that includes ranking bins corresponding to ranges of pixel values such that each pixel value in the sliding pixel window will fall into one of the ranking bins, signifying its pixel rank. The edge detection system 102 progresses through each pixel of the raster image 202, determining its neighborhood in the sliding pixel window, and assigning a pixel rank to the pixel according to its local (histogram-based) pixel ranking. In some cases, a local ranking includes or refers to a ranking of pixels within a neighborhood (enclosed by a pixel window) according to their pixel values. Along these lines, a local histogram ranking includes or refers to a histogram-based ranking of pixels according to which ranking bin the pixel values fall within the ranking bins of a pixel rank histogram.

For the area differentiation stage, the edge detection system 102 determines an edge strength indicated by the difference between minimum and maximum pixel values within a local neighborhood. For example, the edge detection system 102 compares pixel values or pixel ranks of pixels as indicated by a local (histogram) ranking of pixels. In some embodiments, through such a comparison, the edge detection system 102 determines a minimum pixel value (or pixel rank) and a maximum pixel value (or pixel rank) within a local pixel neighborhood (e.g., within a sliding pixel window). Additionally, in certain embodiments, the edge detection system 102 determines a difference between the minimum and maximum pixel values (or pixel ranks), thus signifying the edge strength associated with the local pixel neighborhood (as indicated by the sliding pixel window at the given location in the raster image 202). In some cases, the edge detection system 102 determines contrasts between adjacent regions (or pixel window locations) indicated by their edge strengths to reveal or detect edges depicted in the raster image 202.

As also illustrated in FIG. 2, the edge detection system 102 utilizes a segmentation neural network 206 (e.g., the segmentation neural network 118). More particularly, the edge detection system 102 utilizes the segmentation neural network 206 in conjunction with the pixel window algorithm 204 to detect edges of the raster image 202. For example, the edge detection system 102 utilizes the segmentation neural network 206 in the form of a convolutional neural network trained on image datasets to recognize and isolate depicted objects as defined by their object edges or object contours. The edge detection system 102 further combines the object contours from the segmentation neural network 206 with the detected edges from the pixel window algorithm 204 to determine edges of the raster image 202. Combining the outputs in this way fills gaps and filter out non-object edges or contours for even more accurate edge detection.

In some cases, an edge includes or refers to a collection of (two-dimensional points) connected to denote or define a boundary between regions of an image, such as the outline of an object depicted in the image. Along these lines, in some cases, a contour includes or refers to a collection of one or more edges connected or joined along a boundary of a shape or object in an image, indicating shape and/or structure. For example, a contour is a continuous curve that joins all points along a boundary of a shape. In some embodiments, the edge detection system 102 thus generates a contour by combining one or more detected edges.

In some embodiments, a neural network (e.g., a segmentation neural network) includes or refers to a machine learning model that is trainable and/or tunable based on inputs to generate predictions, determine classifications, or approximate unknown functions. For example, a neural network includes a model of interconnected artificial neurons (e.g., organized in layers) that communicate and learn to approximate complex functions and generate outputs (e.g., image contours or detected objects) based on a plurality of inputs provided to the neural network. In some cases, a neural network refers to an algorithm (or set of algorithms) that implements deep learning techniques to model high-level abstractions in data. For example, a neural network includes a deep neural network, a convolutional neural network, a recurrent neural network (e.g., an LSTM), a graph neural network, a transformer, or a generative neural network (e.g., a generative adversarial neural network or a diffusion neural network).

As shown, the edge detection system 102 thus generates refined edges 208 from the pixel window algorithm 204 and the segmentation neural network 206. From the refined edges 208, the edge detection system 102 further determines or generates edge granularity 210. To elaborate, the edge detection system 102 determines a hierarchical structure of contours or edges included in the refined edges 208. For instance, the edge detection system 102 determines a stratified arrangement of contours corresponding to parent-child relationships among the refined edges 208. Within the hierarchical contours, the edge detection system 102 determines granularity levels of the various edges, where increasing levels indicate greater levels of detail (where each level of edges/contours builds on and includes those of the previous parent levels).

As further illustrated in FIG. 2, the edge detection system 102 performs a contour extrapolation 212. In particular, the edge detection system 102 extrapolates edges for portions of the raster image 202 that are sparse or incomplete. In some cases, the edge detection system 102 detects measures of sparseness among the refined edges 208 (e.g., within the hierarchical contour structure). In addition, the edge detection system 102 uses a linear extrapolation process to fill missing or sparse edges that satisfy a threshold measure of sparseness.

In addition, as shown in FIG. 2, the edge detection system 102 provides tools for freehand tracing 214. More specifically, the edge detection system 102 provides tools for selecting individual edges among the detected edges. For example, the edge detection system 102 uses a hit test to identify or determine a selected edge among edges. Thus, even for complex or tightly packed edges, the edge detection system 102 accurately selects individual edges. In addition, as part of the freehand tracing 214, the edge detection system 102 provides tools for edge smoothening and reference path editing. Using the freehand tracing 214, the edge detection system 102 thus generates a vector image 218 from the raster image 202 with the edges converted into vector paths or segments.

As further shown, the edge detection system 102 facilitates one-click tracing 216. For example, the edge detection system 102 provides a selectable option for converting the raster image 202 into the vector image 218. In response to a single interaction selecting the option, the edge detection system 102 seamlessly traces all detected contours/edges in the raster image 202 (using the pixel window algorithm 204, the segmentation neural network 206, the edge granularity 210 and/or the contour extrapolation 212). In some cases, the edge detection system 102 further provides a toggle option for switching back and forth between vectorized and raster versions of a digital image, along with interface tools for defining edge granularity and smoothness. To perform tracing functions, either for one-click tracing 216 and/or for freehand tracing 214, in some cases the edge detection system 102 uses a tracing model or algorithm, such as Vectormitate as described by G. Singhal et al. in U.S. patent application Ser. No. 18/483,919, titled VECTOR PATH TRAJECTORY IMITATION, filed Oct. 10, 2023, which is hereby incorporated by reference in its entirety.

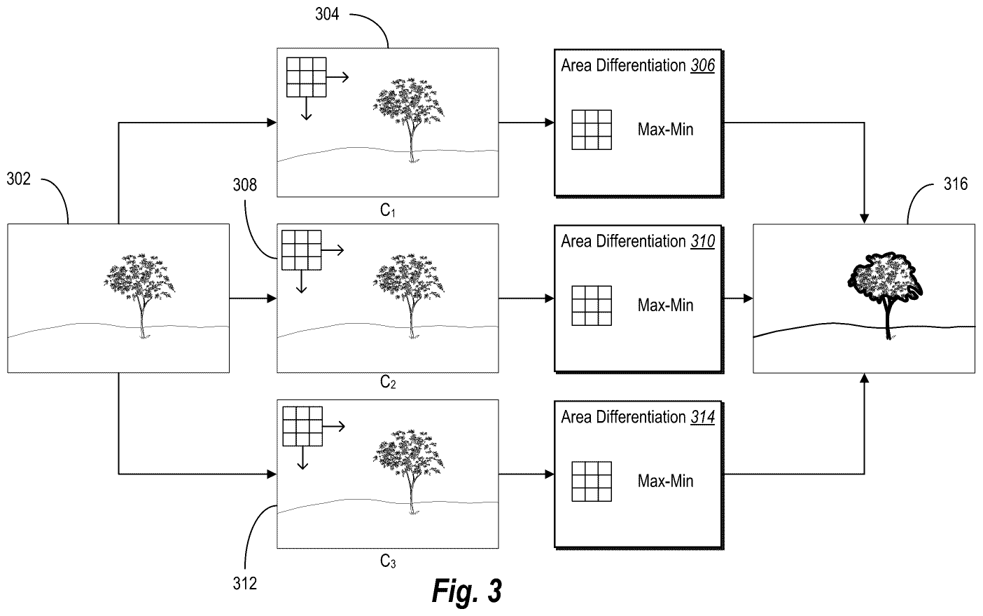

As mentioned above, in certain described embodiments, the edge detection system 102 uses a pixel window algorithm to detect edges of a raster image. In particular, the edge detection system 102 uses a pixel rank algorithm to split a raster image into color channels and perform a two-stage process of area ranking and area differentiation to detect depicted edges. FIG. 3 illustrates an example of using a pixel window algorithm to detect edges of a raster image in accordance with one or more embodiments.

As illustrated in FIG. 3, the edge detection system 102 identifies or receives a raster image 302. For instance, the edge detection system 102 receives the raster image 302 as a selection or an upload from a client device (e.g., the client device 108). In addition, the edge detection system 102 splits, divides, or separates the raster image 302 into color channels. For example, the edge detection system 102 splits the raster image 302 into three color channels: red, green, and blue. The edge detection system 102 thus generates channel-specific versions of the raster image 302, where channel-specific pixel values in each version reflect intensities or magnitudes of the respective colors.

As shown, the edge detection system 102 splits the raster image 302 into a first color channel C1, such as a red channel. As part of the pixel window algorithm, the edge detection system 102 performs an area ranking 304 and an area differentiation 306. For the area ranking 304, the edge detection system 102 computes a channel-specific local ranking of channel-specific pixel values. Specifically, the edge detection system 102 utilizes a sliding pixel window to define a neighborhood for a target pixel. The edge detection system 102 further utilizes a pixel rank histogram to determine ranking bins within the histogram where the pixel values (e.g., channel-specific pixel values) of the pixels in the neighborhood (e.g., enclosed by the sliding pixel window) belong. For instance, the edge detection system 102 generates a pixel rank histogram with a first bin for a first range of values (e.g., 0-50), a second bin with a second range of values (e.g., 51-100), a third bin for a third range of values, (e.g., 101-150) and so on for a number of ranking bins and/or for a range of pixel values (e.g., 0-255). The edge detection system 102 thus assigns a ranking bin to each pixel in the sliding pixel window and assigns a new value—a channel-specific pixel rank—to the target pixel based on its position in the ranking (e.g., the local histogram ranking).

The edge detection system 102 proceeds to determine and assign channel-specific pixel ranks for additional pixels of the C1 color channel. For example, the edge detection system 102 moves, increments, or slides the sliding pixel window to the next position to indicate a new target pixel, define the neighborhood for the target pixel, and perform a new channel-specific (histogram-based) ranking of pixel values for the neighborhood enclosed by the window. Indeed, the edge detection system 102 progresses through each pixel by sliding the pixel window and assigning new channel-specific pixel ranks to each pixel according to their respective local histogram rankings. In some embodiments, the area ranking 304 involves a row-by-row approach where the edge detection system 102 assigns pixel ranks to pixels in each column (or each pixel) of the first row before proceeding to the next row. The area ranking 304 further includes a boundary condition to prevent the sliding window from exceeding boundaries of the color channel or the raster image 302.

Along these lines, in some embodiments, the edge detection system 102 implements the area ranking 304 using an algorithm represented by the following pseudo code which defines the process of using a sliding pixel window, advancing the window through columns/pixels in a row to update pixel ranks based on histogram bins, and advancing the window through the rows:

```
AreaRank
Data: nDestMat, nInputMat, window dimensions, rank value, direction
Result: Rank-filtered image in nDestMat
begin
  aTWin, aLWin, aHPtr ← uninitialized integer pointers
  aHist[256] ← empty array of integers
  aXCount ← nInputMat.cols
  aYCount ← nInputMat.rows
  aZCount ← 3
  aDstRow ← nInputMat.cols
  aSrcRow ← nInputMat.cols
  aDstBump ← aDstRow − aXCount
  aSrcBump ← (aSrcRow − aXCount) + 1
  aWinBump ← aSrcRow − nWinWidth
  aNxtBump ← aSrcRow
  aDirOffset ← 0
  aIndex, aCount, aPixel, x, y, wy ← uninitialized integers
  if nDirection > 0 then
    aDirOffset ← nWinHeight − 1;
    Decrement aWinBump and aNxtBump
  else
    Increment aWinBump and aNxtBump
  nDestMat.create(nInputMat.size( ), CV8U);
  Initialize aDst and sSrc pointers
  y ← aYCount;
  repeat
    Clear out histogram.
    Refill histogram
    if aLWin + nWinWidth + aWinBump * (nWinHeight − 1) >
  nInputMat.ptr<uint8>( ) + nInputMat.total( ) * nInputMat.channels( )
  then
      break;
    Find initial bin
    x ← aXCount;
    x > 0 Update histogram.
    repeat
      Subtract the trailing bins
      Add the leading bins
      Decrement wy
    until wy > 0
    Readjust index to bin
    aPixel ← aHist[aIndex];
    aDst ← aDst + aDstBump;
    aSrc ← aSrc + aSrcBump;
    decrement y
  until y > 0
```

By using the histogram-based approach with the sliding pixel window, the edge detection system 102 is less susceptible to noise than some prior systems (e.g., prior systems that use median filters), and the edge detection system 102 is also able to account for directionality to emphasize edges in particular directions, which is not found in prior systems.

As further illustrated in FIG. 3, the edge detection system 102 performs or executes an area differentiation 306. More particularly, the edge detection system 102 executes the area differentiation 306 as part of carrying out the pixel window algorithm on the C1 color channel extracted from the raster image 302. Indeed, the edge detection system 102 performs the area differentiation 306 based on, or in response to, performing the area ranking 304.

To perform the area differentiation 306, the edge detection system 102 utilizes the re-assign values—the pixel ranks—for the pixels to detect depicted edges. For example, the edge detection system 102 compares pixel ranks within a local neighborhood, such as a neighborhood of pixels enclosed by the sliding pixel window. In some cases, the edge detection system 102 compares pixel ranks to determine a difference between a first (e.g., maximum) pixel rank in the neighborhood and a second (e.g., minimum) pixel rank in the neighborhood. In one or more embodiments, the difference between the pixel ranks (e.g., between the maximum and minimum pixel ranks) indicates or defines an edge strength associated with the local neighborhood. The edge detection system 102 further repeats this process for other neighborhoods enclosed by the sliding pixel window throughout locations within the C1 color channel (or within the raster image 302). Accordingly, the edge detection system 102 determines or generates a number of channel-specific edge strengths by buffering the minimum and maximum pixel ranks of each neighborhood (or sliding pixel window location), effectively revealing the depicted edges by highlighting the contrast between adjacent regions or neighborhoods.

In one or more embodiments, the edge detection system 102 performs the area differentiation 306 according to a particular algorithm. For example, the edge detection system 102 executes computer code to carry out an algorithm for the area differentiation 306 as represented by the following pseudo code which defines the process of comparing pixel ranks to determine edge strengths as described:

```
AreaDiff
Data: nDestMat, nInputMat, window dimensions
Result: Difference-filtered image in nDestMat
begin
aMinWin, aMaxWin, aMinBuf, aMaxBuf, aBuffer ← uninitialized
integer pointers;
aXCount = nDestMat.cols;
aYCount = nDestMat.rows; ;
aZCount = 3;
aSCount = aXCount + nWinWidth;
aDstRow = nDestMat.cols; //nDst.RowBytes( );
aSrcRow = nInputMat.cols; //nSrc.RowBytes( );
aDstBump = aDstRow − aXCount;
aSrcBump = aSrcRow − aSCount;
aBufSize = aSCount * 2;
aVal, aMin, aMax, x, y, w ← uninitialized integers;
Initialize aDst and sSrc pointers
y ← aYCount;
repeat
  aMinBuf ← aBuffer;
  aMaxBuf ← aBuffer + aSCount;
  x ← aSCount;
  repeat
    Set the window for minimum and maximum pixel values
    aMinWin + aSrcRow * nWinHeight >=
    nInputMat.ptr<uint8>( ) +
    nInputMat.total( ) * nInputMat.channels( ) break;
    Scan through the window and find the minimum and maximum
    pixel values
    *aMinBuf++ ← aMin;
    *aMaxBuf++ ← aMax;
  until x > 0
  aMinBuf ← aBuffer;
  aMaxBuf ← aBuffer + aSCount;
  x ← aXCount;
  repeat
    Set the window for minimum and maximum pixel values
    Scan through the window and find the minimum and maximum
    pixel values
    *aDst++ ← aMax − aMin;
  until x > 0
  aDst ← aDst + aDstBump;
  aSrc ← aSrc + aSrcBump;
until y > 0
```

By using the area differentiation 306, the edge detection system 102 is more robust to variations in illumination and texture in the raster image 302, as compared to prior gradient-based systems.

As further illustrated in FIG. 3, the edge detection system 102 performs the two stages of the pixel window algorithm on other color channels as well. Specifically, the edge detection system 102 performs an area ranking 308 and an area differentiation 310 on the C2 color channel (e.g., green). Indeed, the edge detection system 102 performs the area ranking 308 using a sliding pixel window to determine channel-specific pixel ranks for pixels using a pixel rank histogram, as described above. In addition, the edge detection system 102 detects edges using the area differentiation 310 to determine differences between pixel ranks determined via the area ranking 308, as described above. Likewise, the edge detection system 102 performs an area ranking 312 and an area differentiation 314 on the C3 color channel (e.g., blue). Accordingly, the edge detection system 102 generates a set of channel-specific ranking data, such as channel-specific rank-filtered images, as well as differentiation data, such as difference-filtered channel-specific images. By treating each color channel separately, the edge detection system 102 detects edges that are not apparent in grayscale conversion, capturing nuances missed by luminance-based systems.

As shown in FIG. 3, the edge detection system 102 further merges or combines the outputs of the three color channels to generate an contour image 316 with detected edges or contours. To elaborate, the edge detection system 102 combines the edge strengths for edges detected using the two stages of the pixel window algorithm on each of the three color channels. Accordingly, the edge detection system 102 detects or determines edges depicted in the raster image 302, thus generating the contour image 316 that indicates or depicts detected edges.

In one or more embodiments, the edge detection system 102 merges the edge detection data of the color channels using computer code defining a pixel window algorithm represented by the following pseudo code:

```
PixelWindowAlgorithm
Data: nInputMat (Source Image Matrix), nDestMat (Destination Image Matrix)
Result: Output image with the detected contours/edges
begin
aMedWidth ← initialized median width
aEdgWidth ← initialized edge width
aMedOutset ← aMedWidth / 2
aEdgOutset ← aEdgWidth / 2
aMedTotal ← aMedWidth * aMedWidth
aMedRank ← ((aMedTotal % 2) == 0) ? (aMedTotal / 2) : ((aMedTotal / 2) + 1)
channelsInput ← cv::split(nInputMat, channelsInput)
foreach i ∈ [1, 3] do
  AreaRank(channelsDest[i], channelsInput[i], aMedWidth, aMedWidth,
  aMedRank, 0)
  AreaDiff(channelsInput[i], channelsDest[i], aEdgWidth, aEdgWidth)
cv::merge(channelsInput, nInputMat);
cv::adaptiveThreshold(grayInvertedEdges,grayInvertedEdges,255,
cv::ADAPTIVETHRESH_GAUSSIAN_C, cv :: THRESH_BINARY, 11, 2);
contours ← vector to get the detected contours;
hierarchy ← vector to store the hierarchy data of edges;
cv::findContours(grayInvertedEdges,contours,hierarchy,cv::RETR_TREE,cv::CHAIN_A
PPROX_TC89_L1);
contourImage ← cv::Mat::zeros(invertedEdges.size( ),CV_8UC3);
minContourArea ← 50.0;
n ← contours.size( )
foreach i ∈ [1, n] do
  area ← cv::contourArea(contours[i]);
  if area > minContourArea then
    color ← cv::Scalar(rand( )%255, rand( )%255, rand( )%255);
    cv::drawContours(contourImage, contours, i, color, 2, cv::LINE_8,
    hierarchy, 0);
```

As part of the pixel window algorithm, the edge detection system 102 also determines a hierarchy of detected contours or edges. In addition, as part of the pixel window algorithm, the edge detection system 102 converts the raster image 302 to contours or edges. Accordingly, the edge detection system 102 generates the contour image 316 to depict the edges detected via the pixel window algorithm. Additional detail regarding determining the hierarchy is provided below.

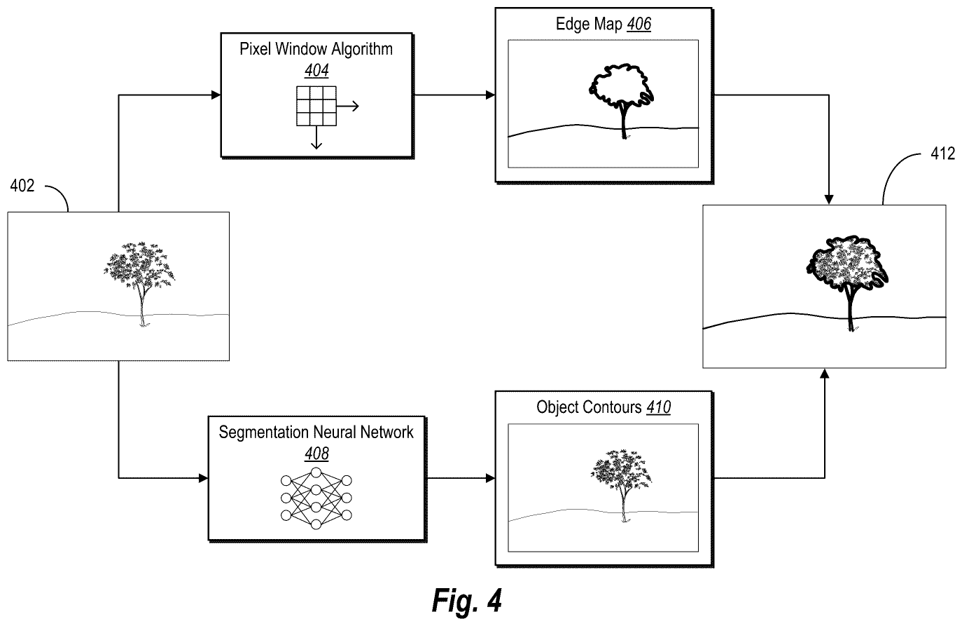

As noted above, in certain described embodiments, the edge detection system 102 utilizes a pixel window algorithm together with a segmentation neural network to detect edges in a raster image. In particular, the edge detection system 102 combines object contours from a segmentation neural network with an edge map from the pixel window algorithm. FIG. 4 illustrates an example process of detecting edges in a raster image using a pixel window algorithm together with a segmentation neural network in accordance with one or more embodiments.

As illustrated in FIG. 4, the edge detection system 102 identifies or receives a raster image 402. In addition, the edge detection system 102 utilizes a pixel window algorithm 404 to process the raster image 402 to detect edges. As described, the pixel window algorithm 404 involves splitting the raster image 402 into color channels, performing area ranking on the color channels, and performing area differentiation on the color channels. In some cases, the pixel window algorithm 404 also includes determining a contour hierarchy and/or performing edge extrapolation. Through the pixel window algorithm 404, the edge detection system 102 generates an edge map 406 that indicates or defines the contours or edges within the raster image 402. For instance, the edge map 406 sometimes takes the form of a contour image that depicts edges detected within the raster image 402. In some cases, the edge map 406 is a data construct that defines, mathematically in matrix form and/or with computer code, the locations of edges within the raster image 402.

As also illustrated in FIG. 4, the edge detection system 102 utilizes a segmentation neural network 408 to process the raster image 402. In particular, the edge detection system 102 utilizes the segmentation neural network 408 to detect objects depicted in the raster image 402, such as trees, people, cars, mountains, animals, toys, household items, or other objects. In some cases, the segmentation neural network 408 is a trained convolutional neural network that performs object segmentation to detect depicted objects. As shown, the edge detection system 102 thus generates object contours 410 using the segmentation neural network 408, where the object contours 410 indicate the edges or contours of detected objects. In addition, the edge detection system 102 refines the object contours 410 using a region-based model to adjust the object contours 410 to match detected edges more closely.

In addition, the edge detection system 102 combines the edge map 406 with the object contours 410. For example, the edge detection system 102 superimposes the object contours 410 onto the edge map 406. In some cases, the edge detection system 102 removes overlapping edges and filters out non-object edges indicated in the edge map 406. Using the pixel window algorithm 404 and the segmentation neural network 408, as shown in FIG. 4, the edge detection system 102 thus generates a contour image 412 that accurately depicts edges or contours, filtering out non-object edges and removing overlapping edges. In some embodiments, the edge detection system 102 generates the contour image 412 in the form of a refined edge map using a combined algorithm for the pixel window algorithm 404 and the segmentation neural network 408. For instance, the edge detection system 102 uses an algorithm represented by the follow pseudo code:

```
CombinedAlgorithm: Enhanced Edge Detection with Object Segmentation
Data: Raster image
Result: Refined edge map (RefinedEdgeMap)
procedure PreprocessImage(image)
  Normalize(image)
  Denoise(image)
  return processedImage
end procedure
procedure DetectEdges(image)
  EdgeMap ← AdvancedEdgeDetection(image)
  return EdgeMap
end procedure
procedure SegmentObjects(image)
  ObjectMasks ← CNNModel(image)
  ObjectContours ← DetectContours(ObjectMasks)
  return ObjectContours
end procedure
procedure RefineEdges(EdgeMap, ObjectContours)
for each contour in ObjectContours do
  IntersectingEdges ← FindIntersections(EdgeMap, contour)
  EdgeMap ← RemoveIntersections(EdgeMap, IntersectingEdges)
  return EdgeMap
end procedure
procedure PostProcess(EdgeMap)
  CleanedEdgeMap ← MorphologicalOperations(EdgeMap)
  return CleanedEdgeMap
end procedure
processedImage ← PreprocessImage(image)
EdgeMap ← DetectEdges(processedImage)
ObjectContours ← SegmentObjects(processedImage)
RefinedEdgeMap ← RefineEdges(EdgeMap, ObjectContours)
RefinedEdgeMap ← PostProcess(RefinedEdgeMap)
return RefinedEdgeMap
```

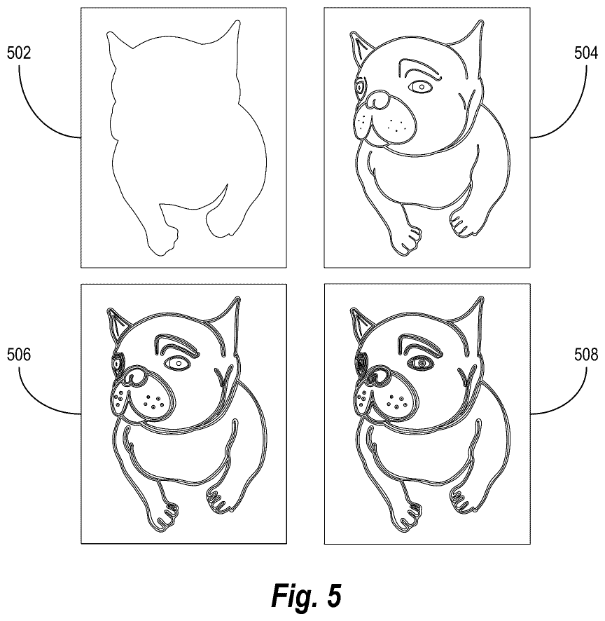

As mentioned above, in one or more embodiments, the edge detection system 102 performs hierarchical contour processing. In particular, the edge detection system 102 generates a hierarchical contour by arranging detected edges in a stratified structure. FIG. 5 illustrates an example set of contour images depicting edges of different hierarchical granularities in accordance with one or more embodiments.

As illustrated in FIG. 5, the edge detection system 102 determines or detects multiple layers, levels, or granularities of edges in a raster image. Indeed, the edge detection system 102 determines outer edges bordering objects, internal edges outlining additional features inside objects, and other edges for levels in between. As shown, the edge detection system 102 generates a contour image 502 depicts edges at a first level of granularity. In addition, the contour image 504 depicts edges at a second level of granularity, the contour image 506 depicts edges at a third level of granularity, and the contour image 508 depicts edges at a fourth level of granularity. In some cases, the edge detection system 102 generates the contour image 502, the contour image 504, the contour image 506, and the contour image 508 by generating a hierarchical contour defining the edges of a raster image arranged in a stratified structure with parent and child layers.

To generate the hierarchical contour, the edge detection system 102 iteratively progresses through levels of edges, from the top level down. In some embodiments, the edge detection system 102 determines edge granularities or levels by performing a recursive depth-first traversal of detected edges (e.g., in a refined edge map). For instance, the edge detection system 102 identifies and accumulates indices of child contours of a current contour index. The edge detection system 102 further uses the indices to recursively invoke the method, processing the next finer granularity level to identify additional parent-child relationships between edges. The edge detection system 102 thus generates a stratified structure of hierarchical contours of an image.

In some cases, the edge detection system 102 generates edges at different granularities using different colors to distinguish between the granularity levels. In addition, the edge detection system 102 uses an area criterion to filter out insignificant contours, focusing on prominent features at each level. In some embodiments, the edge detection system 102 determines or generates a hierarchical contour of edge granularities by using a granularity algorithm. The edge detection system 102 further generates and prints (e.g., provides for display) contour information for edges at each level its level and edge index, facilitating a comprehensive understanding of a structural composition of a raster image. For instance, the edge detection system 102 utilizes a granularity algorithm represented by the following pseudo code:

```
Granularity
Data: contourImage, contours, hierarchy, levelIndices, level
Result: Returns the contours present in the current contour level
selected
begin
nextLevelIndices ← empty vector of next level indices
n ← size of levelIndices
foreach i ∈ [1, n] do
  color ← choose a random RGB color
  area ← get the area of current contour
if area > 100 then
  draw the contours;
childIndex ← hierarchy[i][2]
while childIdx ≠ −1 do
  nextLevelIndices.push_back(childIdx)
  childIdx ← hierarchy[childIdx][0]
if !nextLevelIndices.empty( ) then
  ProcessContoursByLevel(contourImage, contours, hierarchy,
nextLevelIndices, level + 1)
```

By using a granularity algorithm, the edge detection system 102 enables multi-level granular examination of contours in an image, as opposed to prior systems that detect edges in a single level only and cannot therefore adapt to show edges at different levels of detail. Indeed, the contour image 502 depicts level 1 edges at a low level of detail, outlining the boundary of the object. The contour image 504 depicts level 2 edges at outline additional details. Further, the contour image 506 depicts level 3 edges, and the contour image 508 depicts level 4 edges. As shown, each of the levels builds on and includes the edges of the previous level.

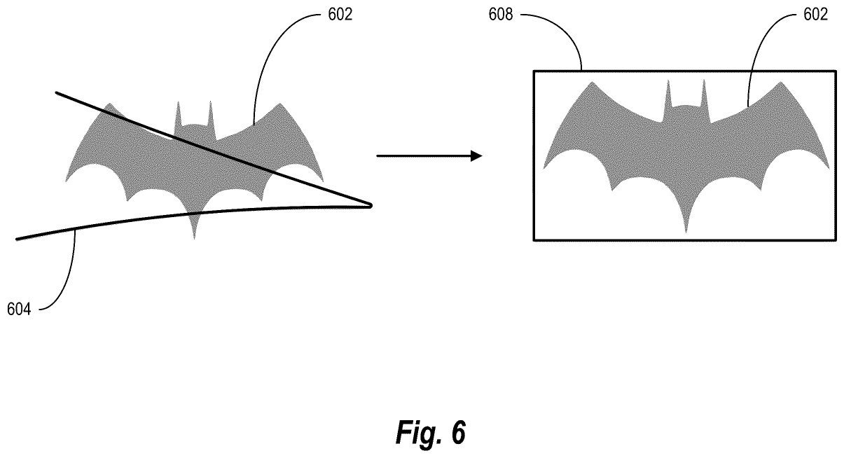

As noted, in some embodiments, the edge detection system 102 extrapolates edges from sparse or incomplete portions of raster image content. In particular, the edge detection system 102 detects sparseness in regions of a raster image and performs an extrapolation process on regions that satisfy a threshold measure of sparseness. FIG. 6 illustrates an example of extrapolating edges in accordance with one or more embodiments.

As illustrated in FIG. 6, the edge detection system 102 generates an initial boundary edge 604 for a digital image 602 before extrapolation. Indeed, in some embodiments, the edge detection system 102 generates a sparsely distributed collection of points upon completion of an edge detection process (e.g., using a pixel window algorithm and/or a segmentation neural network). Given the spatial sparsity of such points, the edge detection system 102 sometimes inaccurately fits curves to borders or boundaries of objects or images.

To correct these errors, the edge detection system 102 performs an extrapolation process to infer or predict unknown edge data from known edge data, beyond the original observation range. The edge detection system 102 performs an extrapolation algorithm that revolves around the output of edge detection (e.g., a refined edge map) that includes a set of edges, each made up of a collection of two-dimensional points. The amalgamation of edges collectively defines a single contour, and the edge detection system 102 uses extrapolation to navigate contours for enhancing fidelity of the overall edge representation. Accordingly, after extrapolation, the edge detection system 102 generates an extrapolated boundary edge 608 for the digital image 602, correcting errors to connect edges and fix the edge shape.

In one or more embodiments, the edge detection system 102 performs a linear extrapolation. To elaborate, the edge detection system 102 uses a linear extrapolation formula given by the following:

$$y ( x ) = {y}_{1} + \frac{x - {x}_{1}}{{x}_{2} - {x}_{1}} ( {y}_{2} - {y}_{1} )$$

where x represents a point to be extrapolated and where (x₁, y₁) and (x₂, y₂) represent endpoints in a linear graph. In some embodiments, the edge detection system 102 performs a different type of extrapolation, such as conic extrapolation or polynomial extrapolation.

In some embodiments, the edge detection system 102 detects sparseness of edges in the raster image 302. For example, the edge detection system 102 labels an edge as sparse when the inter-point distances along a specific contour segment exceed a threshold distance (which often leads to distortion of the original geometric structure of the curve). In some cases, the edge detection system 102 determines sparseness for edges or contour segments by determining Euclidean distances between pairs of points detected via edge detection. A detected edge is sparse when the distance between constituent points (e.g., any two successive or adjacent points or at least a threshold number of successive points) exceeds a distance threshold.

In one or more embodiments, the edge detection system 102 establishes a predefined distance threshold as a heuristic value that achieves a desired shape or structure of an edge or contour. Upon detecting that an edge or a contour segment is sparse, the edge detection system 102 performs an extrapolation process. Specifically, the edge detection system 102 extrapolates additional points to narrow the gap between successive points (in a sparse region) to achieve a distance measure that is less than or equal to the threshold. The linear extrapolation algorithm unfolds systematically as the edge detection system 102 iterates through each point of the edges. Depending on the sparseness at each point, the edge detection system 102 generates additional points between the endpoints of a hypothetical line segment (indicated by the formula above) bookending the sparse region. For example, if the edge detection system 102 uses an extrapolation distance of 1, the edge detection system 102 generates a point that lies precisely 1 Euclidean distance away from the point being analyzed.

Through extrapolation, the edge detection system 102 generates a set of densely populated points for a more detailed, accurate edge or contour. When tracing to fit Bezier curves, the edge detection system 102 thus generates accurate, precise vector images as a result. In some embodiments, the edge detection system 102 performs the extrapolation process by executing an algorithm represented by the following pseudo code:

```
Extrapolation
Data: Original Contours
Result: Return the extrapolated contours
begin
result ← empty vector of vector of 2-D points
threshold ← threshold for the distance between 2 points
extrapolatedDistance ← extrapolation threshold
foreach edge in originalContours do
  modifiedEdge ← vector of 2-D points
  if edge.size( ) < 0 then
    continue
  if edge.size( ) ≤ 1 then
    result.push_back(edge)
    continue
  n ← size of current edge
  foreach i ∈ [1, n] do
    point1 ← edge[i];
    point2 ← empty 2-D point;
    point2 ← edge[0]
    distanceBetweenPoints ← distance between point1 and point2
    if distanceBetweenPoints > threshold then
      modifiedEdge.push_back(point1);
      numberOfPoints ← distanceBetweenPoints/extrapolationDistance
      foreach i ∈ [1, numberOfPoints] do
        d ← extrapolationDistance * i; point ← point at a distance d
        along a line
        modifiedEdge.push_back(point);
    else
      modifiedEdge.push_back(point1)
  result.pushback(modifiedEdge);
return result
```

Through the extrapolation process, the edge detection system 102 thus generates the extrapolated boundary edge for the digital image 602, connected previously unconnected portions of the edge or contour and correcting its shape.

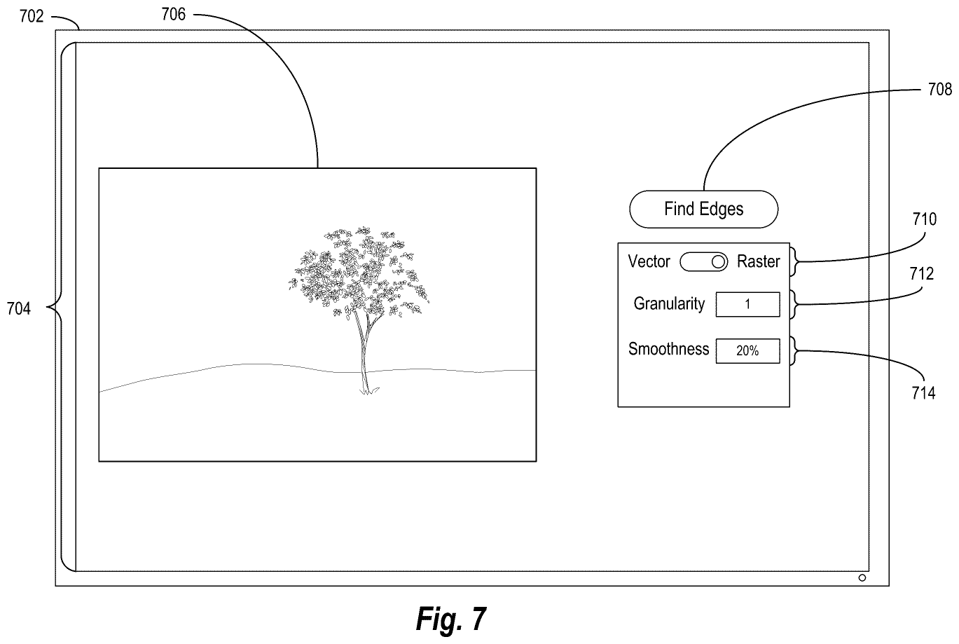

As mentioned above, certain described embodiments, the edge detection system 102 utilizes the advanced edge detection processes described herein to generate vector images from raster images. In particular, the edge detection system 102 utilizes tracing techniques to trace detected edges for fitting vector segments (e.g., Bezier curves) on the detected edges. FIG. 7 illustrates an example interface for tracing tools in accordance with one or more embodiments.

As illustrated in FIG. 7, the client device 702 presents or displays a content editing interface 704 that includes various content editing tools, including tools for detecting, modifying, and/or tracing edges. Within the content editing interface 704, the edge detection system 102 provides a raster image 706 for display. Along with the raster image 706, the edge detection system 102 generates and provides edge detection tools and/or tracing or vectorization tools. For example, the edge detection system 102 provides an edge detection element 708 that is selectable to detect edges depicted in the raster image 706 using the pixel window algorithm, the selection prediction neural network, the contour hierarchy processing, and/or the edge extrapolation discussed above.

In addition, the edge detection system 102 generates and provides a vectorization element 710 selectable to vectorize the raster image 706. In some cases, the edge detection system 102 receives a selection of the vectorization element and, in response, detects edges (as described) and uses a tracing function to generate vector paths to trace detected edges. Indeed, the edge detection system 102 can detect and trace all of the edges in the raster image 706 in response to a single click or a single interaction, thus generating a vector image from the raster image 706 much faster than prior systems are capable of doing. As shown, in some cases, the edge detection system 102 provides the vectorization element 710 in the form of a toggle button to selectively switch back and forth between a vector image and a raster image. In some cases, the edge detection system 102 performs single-click tracing according to a single-click tracing algorithm represented by the following pseudo code:

SingleClickTrace
Data: currentReferenceEdge
Result: Returns the vector of the generated path's anchor data
begin
referenceArtData ← object of ReferencePathData which has the vector
of path segments of the vector paths
referenceArtData.segmentVector ← currentReferenceEdge
referenceArtData.startBezierIndex ← 0
referenceArtData.endBezierIndex ← currentReferenceEdge.size( ) − 2
newCurveData ← get the entire traced vector art for the given reference
art data size ← newCurveData.size( )
tracingStartPoint ← newCurveData.segmentData[0].point
tracingEndPoint ← newCurveData.segmentData[size − 1].point
newAnchorsData←Pass tracingStartPoint and tracingEndPoint to tracing
algorithm, to create a new path with 0 offset
return newAnchorsData

In one or more embodiments, the edge detection system 102 also provides tools for improved freehand tracing of detected edges. For example, the edge detection system 102 improves on existing tracing algorithms by passing detected edges to a tracing algorithm and/or by providing improved selection tools for selecting detected edges to trace.

In some cases, the edge detection system 102 performs a hit test to select one or more edges in response to a user interaction. For instance, the edge detection system 102 performs a hit test based on a cursor location at a time of a selection interaction (e.g., a click) to select a single edge from a collection of multiple intertwined, complex detected edges. In some embodiments, based receiving a first input (e.g., holding a CTRL key, an option key, or some other input that modifies another input), the edge detection system 102 reveals detected edges (of a selected granularity level) in the raster image 706, outlining them or otherwise rendering the edges in the interface. In response to a second input (e.g., a click after or simultaneous with the first input), the edge detection system 102 selects a target edge using a hit test on pre-processed vectors of edges.

To perform the hit test, the edge detection system 102 determines a coordinate location of a cursor (or finger or stylus) when receiving a selection (e.g., the second input). The edge detection system 102 further determines whether the coordinate location falls within or intersects a boundary or edge of a particular edge or contour. The edge detection system 102 thus selects an edge or a contour whose boundary encloses the coordinate location of the selection input.

As shown in the FIG. 7, the edge detection system 102 provides a granularity element 712. In particular, the granularity element 712 provides a tool for setting or selecting a granularity level of edges or contours to show within the raster image 706. In some cases, the edge detection system 102 receives an indication to show level 1 granularity, level 2 granularity, or some other level of granularity up to the level of contours detected and generated from the raster image 706 (and stored in a stratified structure of the contour hierarchy).

As further shown in FIG. 7, the edge detection system 102 provides a smoothness element 714. In particular, the smoothness element 714 provides a tool for setting a smoothness of detected edges of the raster image 706. In one or more embodiments, the edge detection system 102 detects edges that are rugged due to antialiasing or jagged object shapes. In some cases, the edge detection system 102 thus provides a smoothening tool to reduce jagged edges by eliminating surplus anchor points for tracing or vectorizing. Based on receiving increased degrees of smoothness via the smoothness element 714 (e.g., larger percentages), the edge detection system 102 removes more anchor points for more smoothening of detected edges.

In one or more embodiments, the edge detection system 102 provides tools for editing reference paths. For example, the edge detection system 102 provides tools to select and identify particular edges, to remove one or more edges, to truncate edges, and/or to edit detected points of edges. Accordingly, the edge detection system 102 provides flexible, bi-directional tools for editing detected edges to precisely capture desired portions of an image for tracing or vectorizing.

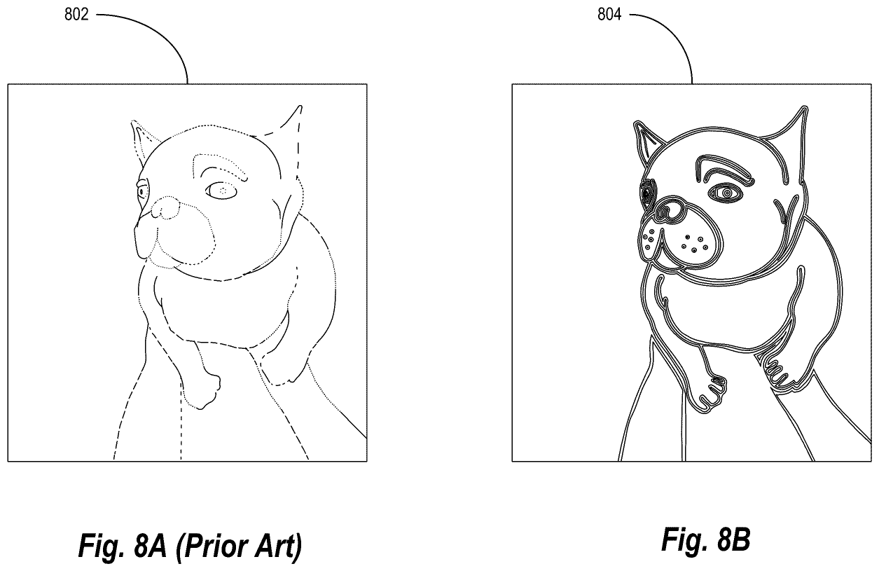

As noted above, in certain embodiments, the edge detection system 102 detects edges more accurately than prior systems. In addition, the edge detection system 102 detects edges at different granularity levels, which many prior systems cannot do. FIGS. 8A-8B illustrate an example comparison of detected edges in accordance with one or more embodiments.

As illustrated in FIG. 8A, the digital image 802 depicts edges detected by a prior system. Specifically, the edges are detected using the Canny edge detector described by G. M. H Amer and A. M. Abushaala in Edge Detection Methods, 2015 2^{nd} World Symposium on Web Applications and Networking, 1-7 (2015). As shown, the edges are in a single layer of granularity and provide inconsistent indications of detail in the digital image 802, with broken and/or sparse regions throughout.

As illustrated in FIG. 8B, the digital image 804 depicts edges detected by the edge detection system 102 described herein. As shown, the detected edges have multiple layers of granularity, each distinctly separated for clarity on each detail or boundary in the digital image 804. Indeed, unlike the Canny model, the edge detection system 102 uses a pixel window algorithm, a segmentation neural network, a contour hierarchy, and/or edge extrapolation to detect and generate clear edges and contours at multiple granularity levels without breaks or errors.

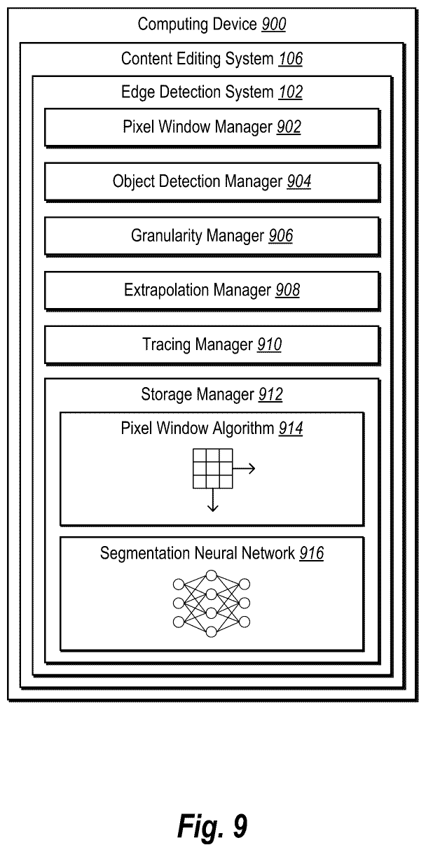

Looking now to FIG. 9, additional detail will be provided regarding components and capabilities of the edge detection system 102. Specifically, FIG. 9 illustrates an example schematic diagram of the edge detection system 102 on an example computing device 900 (e.g., one or more of the client device 108 and/or the server device(s) 104). In some embodiments, the computing device 900 refers to a distributed computing system where different managers are located on different devices, as described above. As shown in FIG. 9, the edge detection system 102 includes a pixel window manager 902, an object detection manager 904, a granularity manager 906, an extrapolation manager 908, a tracing manager 910, and a storage manager 912.

As just mentioned, the edge detection system 102 includes a pixel window manager 902. In particular, the pixel window manager 902 manages, maintains, applies, implements, determines, slides, moves, processes, analyzes, or uses a pixel window algorithm (e.g., the pixel window algorithm 914) to detect edges depicted in a digital image (e.g., a raster image). For example, the pixel window manager 902 generates and uses a sliding pixel window to perform area ranking and area differentiation to determine local (histogram-based) pixel ranks for pixels enclosed by the sliding pixel window and to determine edge strengths from the pixel ranks. The pixel window manager 902 thus detects edges in a digital image based on the contrast between regions enclosed by the sliding pixel window at different locations.

As shown, the edge detection system 102 also includes an object detection manager 904. In particular, the object detection manager 904 manages, maintains, detects, determines, or identifies objects depicted in a digital image (e.g., a raster image). For example, the object detection manager 904 trains and/or implements a segmentation neural network (e.g., the segmentation neural network 916) to detect or determine edges, contours, or boundaries of objects depicted in the digital image. In some cases, the object detection manager 904 works in conjunction with the pixel window manager 902 to further superimpose object contours detected via the segmentation neural network on an edge map generated via the pixel window algorithm, thereby filtering out non-object edges/contours and generating a refined edge map accurately reflecting the contours of the digital image.

As further illustrated in FIG. 9, the edge detection system 102 includes a granularity manager 906. In particular, the granularity manager 906 manages, maintains, determines, identifies, or generates a hierarchical contour of edges or contours arranged in a stratified structure according to granularity levels. For example, the granularity manager 906 determines granularity levels for different detected edges or contours and arranges the edges or contours in a stratified structure according to their respective granularity levels.

Additionally, the edge detection system 102 includes an extrapolation manager 908. In particular, the extrapolation manager 908 manages, maintains, extrapolates, determines, detects, or identifies extrapolated edges in a digital image. For example, the extrapolation manager 908 extrapolates edges from sparse regions of a digital image by interpolating or adding additional points to edges that satisfy a threshold sparseness metric. Indeed, the extrapolation manager 908 determines measures of sparseness for detected edges and further compares the sparseness measures with a sparseness threshold. For regions that meet the sparseness threshold, the extrapolation manager 908 performs an extrapolation process to add additional points and extrapolate edges or contours.

As further illustrated in FIG. 9, the edge detection system 102 includes a tracing manager 910. In particular, the tracing manager 910 manages, maintains, or generates vectorized images from raster images. For example, the tracing manager 910 uses a tracing algorithm to trace detected edges of a raster image and convert the edges into vector paths, such as Bezier curves.

The edge detection system 102 further includes a storage manager 912. The storage manager 912 operates in conjunction with, or includes, one or more memory devices such as a database (e.g., the database 114) that store various data such as raster images, vector images, detected edges, points, and/or vector paths. As shown, the storage manager 912 stores a pixel window algorithm 914 accessible and usable by other components of the edge detection system 102. In some cases, the storage manager 912 also stores a segmentation neural network 916 accessible and usable by other components of the edge detection system 102. The storage manager 912 communicates with the other components of the edge detection system 102 to facilitate the operations and functions described herein.

In one or more embodiments, each of the components of the edge detection system 102 are in communication with one another using any suitable communication technologies. Additionally, the components of the edge detection system 102 is in communication with one or more other devices including one or more client devices described above. It will be recognized that although the components of the edge detection system 102 are shown to be separate in FIG. 9, any of the subcomponents may be combined into fewer components, such as into a single component, or divided into more components as may serve a particular implementation. Furthermore, although the components of FIG. 9 are described in connection with the edge detection system 102, at least some of the components for performing operations in conjunction with the edge detection system 102 described herein may be implemented on other devices within the environment.

The components of the edge detection system 102, in one or more implementations, includes software, hardware, or both. For example, the components of the edge detection system 102 include one or more instructions stored on a computer-readable storage medium and executable by processors of one or more computing devices (e.g., the computing device 900). When executed by the one or more processors, the computer-executable instructions of the edge detection system 102 cause the computing device 900 to perform the methods described herein. Alternatively, the components of the edge detection system 102 comprises hardware, such as a special purpose processing device to perform a certain function or group of functions. Additionally, or alternatively, the components of the edge detection system 102 includes a combination of computer-executable instructions and hardware.

Furthermore, the components of the edge detection system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the edge detection system 102 may be implemented as part of a stand-alone application on a personal computing device or a mobile device. Alternatively, or additionally, the components of the edge detection system 102 may be implemented in any application that allows creation and delivery of marketing content to users, including, but not limited to, applications in ADOBE® EXPERIENCE MANAGER and CREATIVE CLOUD®, such as ADOBE® PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

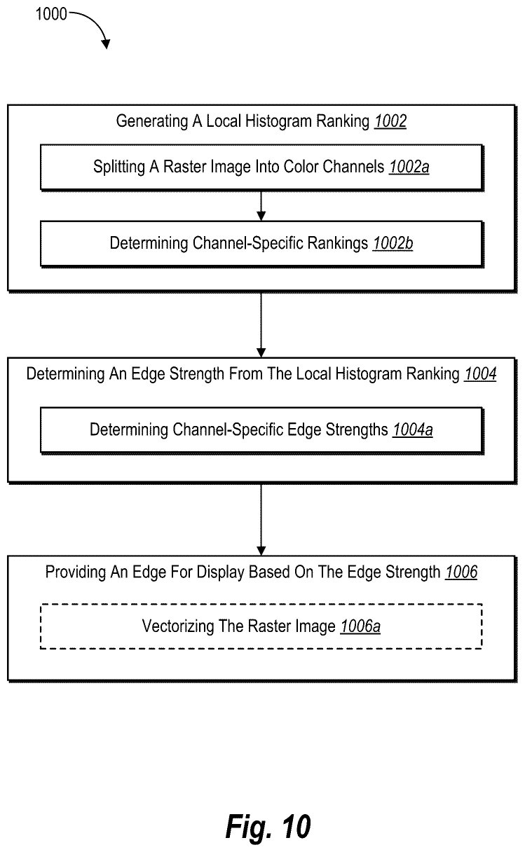

FIGS. 1-9, the corresponding text, and the examples provide a number of different systems, methods, and non-transitory computer readable media for detecting or generating edges in raster images using a pixel window algorithm and/or a segmentation neural network. In addition to the foregoing, embodiments are describable in terms of flowcharts comprising acts for accomplishing a particular result. For example, FIGS. 10-12 illustrate flowcharts of example sequences or series of acts in accordance with one or more embodiments.

While FIGS. 10-12 illustrate acts according to particular embodiments, alternative embodiments may omit, add to, reorder, and/or modify any of the acts shown in FIGS. 10-12. The acts of FIGS. 10-12 are sometimes performed as part of a method. Alternatively, a non-transitory computer readable medium comprises instructions, that when executed by one or more processors, cause a computing device to perform the acts of FIGS. 10-12. In still further embodiments, a system performs the acts of FIGS. 10-12. Additionally, the acts described herein may be repeated or performed in parallel with one another or in parallel with different instances of the same or other similar acts.

FIG. 10 illustrates an example series of acts 1000 for detecting edges in a raster image using a pixel window algorithm. In particular, the series of acts 1000 includes an act 1002 of generating a local histogram ranking. For example, the act 1002 involves generating, for a sliding pixel window in a raster image, a local histogram ranking of pixels according to pixel values located within the sliding pixel window. In some embodiments, the act 1002 includes an act 1002a of splitting a raster image into color channels. In some cases, the act 1002a involves splitting the raster image into color channels that indicate channel-specific pixel values for the pixels located in the sliding pixel window. Additionally, the act 1002 includes an act 1002b of determining channel-specific rankings. For instance, the act 1002b involves determining channel-specific rankings of the pixels according to the channel-specific pixel values.

In addition, the series of acts 1000 includes an act 1004 of determining an edge strength from the local histogram ranking. In particular, the act 1004 involves determining, for a region of the raster image enclosed by the sliding pixel window, an edge strength for an edge depicted in the raster image by comparing pixel ranks indicated by the local histogram ranking of the pixels. For example, the act 1004 includes an act 1004a of determining channel-specific edge strengths. In some cases, the act 1004a involves determining channel-specific edge strengths for the color channels by comparing channel-specific pixel ranks indicated by the channel-specific rankings of the pixels. In some embodiments, the series of acts 1000 also includes an act of combining channel-specific edge strengths into the edge strength for the edge depicted in the raster image.

As further illustrated in FIG. 10, the series of acts 1000 includes an act 1006 of providing an edge for display based on the edge strength. In particular, the act 1006 involves providing the edge for display based on determining the edge strength for the region of the raster image enclosed by the sliding pixel window. For example, the act 1006 includes an act 1006a of vectorizing the raster image. In some cases, the act 1006a involves generating a vector image from the raster image by using a tracing model that converts the edge depicted in the raster image to a vector path.

In one or more embodiments, the series of acts 1000 includes an act of generating the local histogram ranking of the pixels by using a pixel rank histogram that indicates ranking bins corresponding to the pixel values within the sliding pixel window. Further, the series of acts 1000 includes an act of updating the pixel rank histogram to indicate additional pixel values for different locations of the sliding pixel window within the raster image.

In some embodiments, the series of acts 1000 includes an act of detecting object contours for an object depicted in a raster image utilizing a segmentation neural network and an act of determining the edge depicted in the raster image by superimposing the object contours for the object onto an edge map indicated by the pixel ranks. In these or other embodiments, the series of acts 1000 includes an act of determining one or more additional edges depicted in the raster image according to the pixel ranks indicated by the local histogram ranking of the pixels. In addition, the series of acts 1000 includes an act of determining granularity levels associated with the edge and the one or more additional edges. Further, the series of acts 1000 includes an act of generating a hierarchical contour for the raster image by arranging the edge and the one or more additional edges in a stratified structure according to the granularity levels.

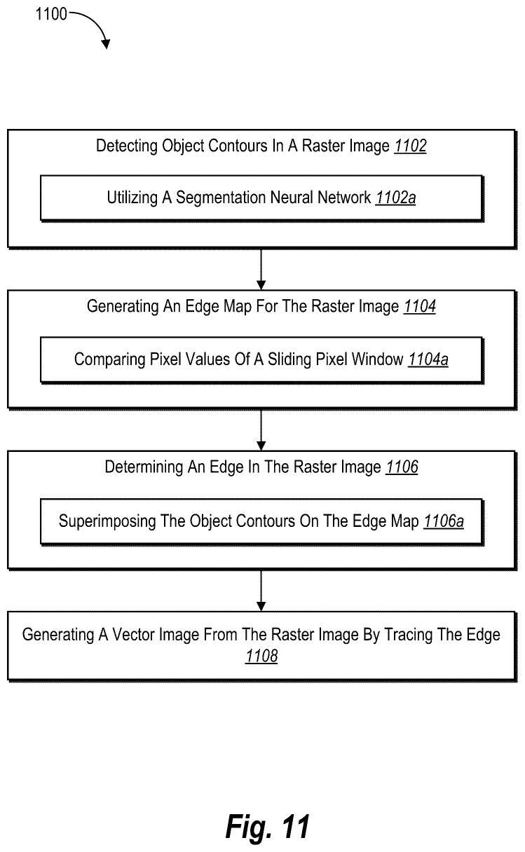

FIG. 11 illustrates an example series of acts 1100 for generating a vector image from a raster image by detecting and tracing edges using a pixel window algorithm and an object segmentation neural network. In particular, the series of acts 1100 includes an act 1102 of detecting object contours in a raster image. For example, the act 1102 involves detecting, utilizing a segmentation neural network, object contours for an object depicted in a raster image. Indeed, in some cases, the act 1102 includes an act 1102a of utilizing a segmentation neural network.

As shown, the series of acts 1100 includes an act 1104 of generating an edge map for the raster image. In particular, the act 1104 includes an act 1104a of comparing pixel values of a sliding pixel window. For example, the act 1104a involves generating an edge map for the raster image by comparing pixel values of pixels located within a sliding pixel window located at various positions within the raster image.

As also shown in FIG. 11, the series of acts 1100 includes an act 1106 of determining an edge in the raster image. In particular, the act 1106 includes an act 1106a of superimposing the object contours on the edge map. For example, the act 1106a involves determining an edge depicted in the raster image by superimposing the object contours for the object onto the edge map indicated by the sliding pixel window.

Additionally, the series of acts 1100 includes an act 1108 of generating a vector image from the raster image by tracing the edge. For example, the act 1108 involves generating, utilizing a tracing model, a vector image from the raster image by tracing the edge indicated by the object contours and the edge map.

In some embodiments, the series of acts 1100 includes an act of generating the edge map by: generating a local ranking of pixels according to pixel values located within the sliding pixel window and determining, for a region of the raster image enclosed by the sliding pixel window, an edge strength for the edge depicted in the raster image by comparing pixel ranks indicated by the local ranking of the pixels. In some cases, the series of acts 1100 includes acts of determining a sparseness for the edge depicted in the raster image according to inter-point distances along a contour segment of the edge and modifying the edge by adding additional points between subsegments of the edge defined by points with inter-point distances that exceed a distance threshold.

In one or more embodiments, the series of acts 1100 includes an act of receiving, from a client device, an interaction selecting the edge from among a plurality of edges depicted in the raster image. In the same or other embodiments, the series of acts 1100 includes an act of, based on the interaction, determining selection of the edge from among the plurality of edges by performing a hit test on a pixel location within the vector image indicated by the interaction.

In certain embodiments, the series of acts 1100 includes an act of determining one or more additional edges depicted in the raster image. In addition, the series of acts 1100 includes an act of determining granularity levels associated with the edge and the one or more additional edges, wherein the granularity levels correspond to levels of detail captured by edges. Further, the series of acts 1100 includes an act of generating a hierarchical contour for the raster image by arranging the edge and the one or more additional edges in a stratified structure according to the granularity levels. In some embodiments, the series of acts 1100 includes an act of superimposing the object contours for the object onto the edge map by filtering out non-object edges and an act of generating the vector image utilizing the tracing model in response to single-click interaction with a client device.

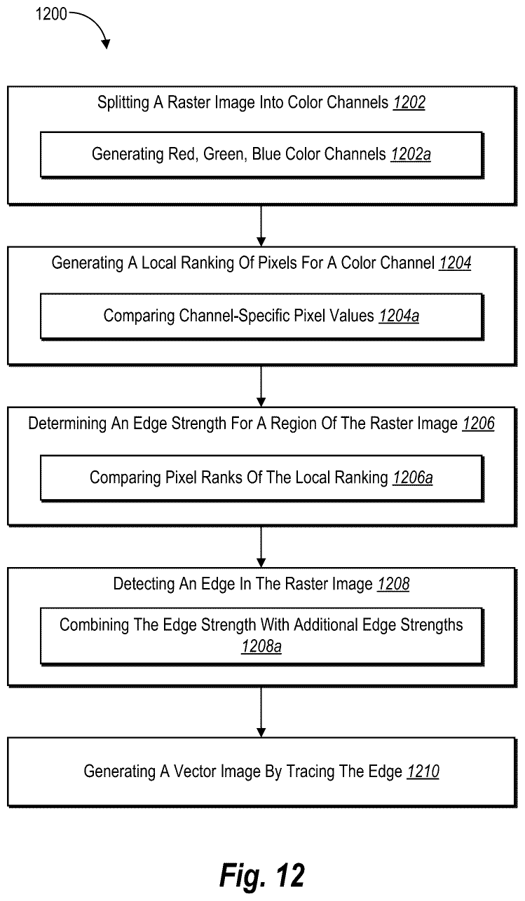

FIG. 12 illustrates an example series of acts 1200 for generating a vector image from a raster image by detecting and tracing edges using a pixel window algorithm for channel-specific analysis. In particular, the series of acts 1200 includes an act 1202 of splitting a raster image into color channels. For example, the act 1202 involves splitting a raster image into a plurality of color channels defining pixel values for pixels depicted in the raster image. In some cases, the act 1202 includes an act 1202a of generating red, green, and blue color channels for the raster image.

As shown, the series of acts 1200 includes an act 1204 of generating a local ranking of pixels for a color channel. In particular, the act 1204 involves generating, for a color channel among the plurality of color channels, a local ranking of pixels located within a sliding pixel window by comparing channel-specific pixel values for the pixels located within the sliding pixel window. Indeed, in some cases, the act 1204 includes an act 1204a of comparing channel-specific pixel values.

As further shown in FIG. 12, the series of acts 1200 includes an act 1206 of determining an edge strength for a region of the raster image. In particular, the act 1206 involves determining, for a region of the raster image enclosed by the sliding pixel window, an edge strength by comparing pixel ranks indicated by the local ranking of pixels for the color channel. Indeed, in some cases, the act 1206 includes an act 1206a of comparing pixel ranks of the local ranking.

In addition, the series of acts 1200 includes an act 1208 of detecting an edge in the raster image. For example, the act 1208 includes detecting an edge depicted in the raster image by combining the edge strength with one or more additional edge strengths corresponding to additional color channels of the plurality of color channels. For example, the act 1208 includes an act 1208a of combining the edge strength with additional edge strengths.

In some embodiments, the series of acts 1200 includes an act 1210 of generating a vector image by tracing the edge. For example, the act 1210 involves generating a vector image from the raster image by tracing the edge depicted in the raster image using a tracing algorithm.

In some embodiments, the series of acts 1200 includes an act of generating additional local rankings of the pixels located within the sliding pixel window by comparing additional channel-specific pixel values corresponding to additional color channels among the plurality of color channels. In these or other embodiments, the series of acts 1200 includes an act of determining the one or more additional edge strengths from the additional local rankings.

In some cases, the series of acts 1200 includes an act of detecting object contours for an object depicted in a raster image utilizing a segmentation neural network. In addition, the series of acts 1200 includes an act of generating an edge map comprising the edge and one or more additional edges indicated by comparing the pixel ranks indicated by the sliding pixel window. Further, the series of acts 1200 includes an act of determining the edge depicted in the raster image by superimposing the object contours for the object onto the edge map.

In one or more embodiments, the series of acts 1200 includes an act of determining one or more additional edges depicted in the raster image. In addition, the series of acts 1200 includes an act of determining granularity levels associated with the edge and the one or more additional edges, wherein the granularity levels correspond to levels of detail captured by edges. Further, the series of acts 1200 includes an act of generating a hierarchical contour for the raster image by arranging the edge and the one or more additional edges in a stratified structure according to the granularity levels.

In certain embodiments, the series of acts 1200 includes an act of determining a sparseness for the edge depicted in the raster image according to inter-point distances along a contour segment of the edge. Further, the series of acts 1200 includes an act of modifying the edge by adding additional points between subsegments of the edge defined by points with inter-point distances that exceed a distance threshold. In some cases, the series of acts 1200 includes acts of determining a sparseness for the edge depicted in the raster image and modifying the edge by extrapolating additional points according to inter-point distances along the edge.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., computing device 900, server device(s) 104, and/or client device 108). In one or more embodiments, the computing device 1300 may be a mobile device (e.g., a mobile telephone, a smartphone, a PDA, a tablet, a laptop, a camera, a tracker, a watch, a wearable device, etc.). In some embodiments, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1313). While the computing device 1300 is shown in FIG. 13, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, the storage device 1306 can include a non-transitory storage medium described above. The storage device 1306 may include a hard disk drive (HDD), flash memory, a Universal Serial Bus (USB) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI. The computing device 1300 can further include a bus 1313. The bus 1313 can include hardware, software, or both that connects components of computing device 1300 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
generating, for a sliding pixel window in a raster image, a local histogram ranking of pixels according to pixel values located within the sliding pixel window;
determining, for a region of the raster image enclosed by the sliding pixel window, an edge strength for an edge depicted in the raster image by comparing pixel ranks indicated by the local histogram ranking of the pixels; and
providing the edge for display based on determining the edge strength for the region of the raster image enclosed by the sliding pixel window.

2. The method of claim 1, wherein determining the local histogram ranking of the pixels comprises:
splitting the raster image into color channels that indicate channel-specific pixel values for the pixels located in the sliding pixel window; and
determining channel-specific rankings of the pixels according to the channel-specific pixel values.

3. The method of claim 2, wherein determining the edge strength for the edge depicted in the raster image comprises:
determining channel-specific edge strengths for the color channels by comparing channel-specific pixel ranks indicated by the channel-specific rankings of the pixels; and
combining channel-specific edge strengths into the edge strength for the edge depicted in the raster image.

4. The method of claim 1, further comprising:
generating the local histogram ranking of the pixels by using a pixel rank histogram that indicates ranking bins corresponding to the pixel values within the sliding pixel window; and
updating the pixel rank histogram to indicate additional pixel values for different locations of the sliding pixel window within the raster image.

5. The method of claim 1, wherein providing the edge for display comprises generating a vector image from the raster image by using a tracing model that converts the edge depicted in the raster image to a vector path.

6. The method of claim 1, further comprising:
detecting object contours for an object depicted in a raster image utilizing a segmentation neural network; and
determining the edge depicted in the raster image by superimposing the object contours for the object onto an edge map indicated by the pixel ranks.

7. The method of claim 1, further comprising:
determining one or more additional edges depicted in the raster image according to the pixel ranks indicated by the local histogram ranking of the pixels;
determining granularity levels associated with the edge and the one or more additional edges; and
generating a hierarchical contour for the raster image by arranging the edge and the one or more additional edges in a stratified structure according to the granularity levels.

8. A system comprising:
a memory component; and
one or more processing devices coupled to the memory component, the one or more processing devices to perform operations comprising:
detecting, utilizing a segmentation neural network, object contours for an object depicted in a raster image;
generating an edge map for the raster image by comparing pixel values of pixels located within a sliding pixel window located at various positions within the raster image;
determining an edge depicted in the raster image by superimposing the object contours for the object onto the edge map indicated by the sliding pixel window; and
generating, utilizing a tracing model, a vector image from the raster image by tracing the edge indicated by the object contours and the edge map.

9. The system of claim 8, wherein generating the edge map comprises:
generating a local ranking of pixels according to pixel values located within the sliding pixel window; and
determining, for a region of the raster image enclosed by the sliding pixel window, an edge strength for the edge depicted in the raster image by comparing pixel ranks indicated by the local ranking of the pixels.

10. The system of claim 8, wherein the operations further comprise:
determining a sparseness for the edge depicted in the raster image according to inter-point distances along a contour segment of the edge; and
modifying the edge by adding additional points between subsegments of the edge defined by points with inter-point distances that exceed a distance threshold.

11. The system of claim 8, wherein the operations further comprise:
receiving, from a client device, an interaction selecting the edge from among a plurality of edges depicted in the raster image; and
based on the interaction, determining selection of the edge from among the plurality of edges by performing a hit test on a pixel location within the vector image indicated by the interaction.

12. The system of claim 8, wherein the operations further comprise:
determining one or more additional edges depicted in the raster image;
determining granularity levels associated with the edge and the one or more additional edges, wherein the granularity levels correspond to levels of detail captured by edges; and
generating a hierarchical contour for the raster image by arranging the edge and the one or more additional edges in a stratified structure according to the granularity levels.

13. The system of claim 8, wherein superimposing the object contours for the object onto the edge map comprises filtering out non-object edges.

14. The system of claim 8, wherein the operations further comprise generating the vector image utilizing the tracing model in response to single-click interaction with a client device.

15. A non-transitory computer readable medium storing instructions which, when executed by a processing device, cause the processing device to perform operations comprising:
splitting a raster image into a plurality of color channels defining pixel values for pixels depicted in the raster image;
generating, for a color channel among the plurality of color channels, a local ranking of pixels located within a sliding pixel window by comparing channel-specific pixel values for the pixels located within the sliding pixel window;
determining, for a region of the raster image enclosed by the sliding pixel window, an edge strength by comparing pixel ranks indicated by the local ranking of pixels for the color channel;
detecting an edge depicted in the raster image by combining the edge strength with one or more additional edge strengths corresponding to additional color channels of the plurality of color channels; and
generating a vector image from the raster image by tracing the edge depicted in the raster image.

16. The non-transitory computer readable medium of claim 15, wherein the operations further comprise:
generating additional local rankings of the pixels located within the sliding pixel window by comparing additional channel-specific pixel values corresponding to additional color channels among the plurality of color channels; and
determining the one or more additional edge strengths from the additional local rankings.

17. The non-transitory computer readable medium of claim 15, wherein the operations further comprise:
detecting object contours for an object depicted in a raster image utilizing a segmentation neural network;
generating an edge map comprising the edge and one or more additional edges indicated by comparing the pixel ranks indicated by the sliding pixel window; and
determining the edge depicted in the raster image by superimposing the object contours for the object onto the edge map.

18. The non-transitory computer readable medium of claim 15, wherein the operations further comprise:
determining one or more additional edges depicted in the raster image;
determining granularity levels associated with the edge and the one or more additional edges, wherein the granularity levels correspond to levels of detail captured by edges; and
generating a hierarchical contour for the raster image by arranging the edge and the one or more additional edges in a stratified structure according to the granularity levels.

19. The non-transitory computer readable medium of claim 15, wherein the operations further comprise:
determining a sparseness for the edge depicted in the raster image according to inter-point distances along a contour segment of the edge; and
modifying the edge by adding additional points between subsegments of the edge defined by points with inter-point distances that exceed a distance threshold.

20. The non-transitory computer readable medium of claim 15, wherein the operations further comprise:
determining a sparseness for the edge depicted in the raster image; and
modifying the edge by extrapolating additional points according to inter-point distances along the edge.
